(19) United States
(12) Patent Application Publication
(10) Pub. No.: US 2026/0123768 A1
(43) Pub. Date: May 7, 2026

(54) PARTITIONED FOAM CORE AND FOAM MATTRESS

(71) Applicant: Guangdong Sweetnight Technical Innovation Ltd. Co., Guangzhou (CN)

(72) Inventors: Shuimu HUANG, Foshan (CN); Eason CHEN, Guangzhou (CN); Runlan REN, Huizhou (CN); Liang CHEN, Guangzhou (CN); Qinghuang ZENG, Guangzhou (CN)

(21) Appl. No.: 18/937,676

(22) Filed: Nov. 5, 2024

(51) Int. Cl. A47C 27/16; A47C 27/14; B32B 3/08; B32B 3/30; B32B 5/18; B32B 5/32

(52) U.S. Cl. CPC A47C 27/16; A47C 27/144; B32B 3/08; B32B 3/30; B32B 5/18; B32B 5/32

(57) ABSTRACT

A foam mattress with an adjustable firmness by inserting or removing filling bodies into openings on at least one side thereof is disclosed. The adjustment of the firmness may be performed by an owner/user of the mattress. The ridged patterns may form openings that enable the insertion and or removal of filling bodies that provide further adjustments to the firmness (or softness) of the mattress in addition to the other factors discussed above. The mattress may also be partitioned to allow the firmness on a first portion of the mattress to be adjusted independently of the firmness of a second portion of the mattress, and vice versa.

### BACKGROUND

### 1. Field

The present disclosure is directed to foam mattresses, and more particularly, foam mattresses with multiple layers.

### 2. Description of Related Art

Foam mattresses are often times used as an alternative to spring mattresses. Many of these foam mattresses are partitioned into multiple layers. These layers serve different purposes to enhance various aspects of the mattress performance, such as its support, its comfort, and its durability.

A top layer (i.e., the layer upon which a person lies) may be referred to as a comfort layer. The comfort layer may comprise various materials such as memory foam, gel-infused foam, or other soft materials. This layer may provide a cushioned feel for a person lying there upon, and may contour to the person's body. The comfort layer may also provide pressure relief.

A transition layer may be disposed immediately under the comfort layer. This layer may provide a transition from the softness of the comfort layer to one or more layers underneath that provide support for the body weight of the person lying on the comfort layer. Higher density foam, which may provide additional support, may be used in making the transition layer.

A support core provides foundational support for the mattress, being disposed underneath the transition layer. This layer is comprised of high-density foam, and provide the primary support for the mattress. In providing this support, the support core ensures the durability of the mattress and its ability to maintain its shape over time. Some mattresses may also include a base layer underneath the support core for additional stability and support.

### SUMMARY

Various embodiments of a foam mattress are disclosed. In one embodiment, a foam mattress includes a first foam layer and a second foam layer. A top surface of the second foam layer is in contact with a bottom surface of the first foam layer. The top surface of the second foam layer is formed with a first ridged pattern having a first plurality of ridges. The first ridged pattern has a first dimension between two ridges of the first plurality of ridges, and a second dimension in a trough (or bottom) between ridges of the first plurality of ridges. A firmness of the mattress is dependent on a ratio of the first dimension and the second dimension.

In one embodiment, a first instance of the mattress in which the second dimension is greater than the first dimension has a greater firmness than a second instance of the mattress in which the first dimension is greater than the second dimension.

In various embodiments, the firmness may further depend on vertical dimensions of the ridges. Ones of the plurality of ridges have a first height from a trough between ones of the plurality of ridges to a top of ones of the plurality of ridges, and a second height between the trough of between ones of the plurality of ridges and a bottom surface of the respective foam layer. The firmness of the mattress is further dependent on a ratio of the first height to the second height Embodiments with more than two foam layers are also possible and contemplated. One or more of the additional foam layers may also include ridged patterns on their respective top surfaces. With regard to the bottom surfaces of various ones of the layers, the surfaces may either be substantially flat or may have a ridged pattern that is complementary to and conforms with that of the layer beneath it.

The disclosure further contemplates a foam mattress with an adjustable firmness by inserting or removing filling bodies into openings on at least one side thereof. The adjustment of the firmness may be performed by an owner of the mattress. The ridged patterns may form openings that enable the insertion and or removal of filling bodies that provide further adjustments to the firmness (or softness) of the mattress in addition to the other factors discussed above. In some embodiments, the mattress may be partitioned to allow the firmness on a first portion of the mattress to be adjusted independently of the firmness of a second portion of the mattress.

### BRIEF DESCRIPTION OF THE DRAWINGS

The above and/or other aspects will become apparent and more readily appreciated from the following description of example embodiments, taken in conjunction with the accompanying drawings, in which:

FIG. 1 is a perspective view of one embodiment of a foam mattress in accordance with the disclosure.

FIGS. 2A and 2B illustrate side views of ridge patterns that may be cut into a layer of a foam mattress in accordance with the disclosure.

FIGS. 3A and 3B illustrate side views of foam layers of a mattress having complementary and conformal ridge patterns.

FIGS. 4A and 4B illustrate side views of mattresses having multiple layers with different ridge patterns.

FIGS. 5A and 5B illustrate side views of mattresses having multiple layers with different ridge patterns and filling bodies disposed between selected ones of the ridges.

FIG. 6 is a flow diagram illustrating a method for manufacturing a foam mattress according to the disclosure.

FIG. 7 is a perspective view of one embodiment of a foam mattress having an adjustable firmness using filling bodies in accordance with the disclosure.

FIG. 8 is a perspective view of another embodiment of a foam mattress having an adjustable firmness using filling bodies in accordance with the disclosure.

FIG. 9 is a perspective view of one embodiment of a filling body in accordance with the disclosure.

FIG. 10 is a flow diagram illustrating a method for adjusting a firmness of a foam mattress.

### DETAILED DESCRIPTION

Foam mattresses are typically divided into two or more layered sections that may be placed on top of one another. These different foam layers may have varying degrees of firmness to meet the overall desired firmness of the mattress. The layers may be cut from foam using ordinary cutting technology. The foam layers of a given mattress may have different levels of firmness, and may be bonded to other foam layers to complete the mattress.

Typical foam mattresses may be cut flat at the layer boundaries that bond the various foam layers to one another. This may increase the difficulty in controlling the desired firmness, thereby having an undesired impact on the comfort of the finished mattress. Furthermore, segmented bonding of this type of mattress may risk separation between two otherwise bonded layers. Weight and materials waste may also occur during the manufacturing of these types of foam mattresses.

The foam mattress of the present disclosure may overcome these issues, resulting in a mattress that can be manufactured using less material and/or at a lower weight, while providing better control of the overall firmness to achieve a desired level of comfort.

A foam core mattress according to the disclosure may be made using multiple foam layers, with special cutting shapes on the surfaces that are in contact with other foam layers. In various embodiments, the cutting patterns on the surfaces of at least some of the layers may comprise a ridge-shaped pattern having a plurality of ridges. Through control of the shape and dimensions of the ridges, the firmness of a given instance of a mattress according to the disclosure may be more precisely controlled. Various embodiments of a foam mattress according to the disclosure are now discussed in further detail.

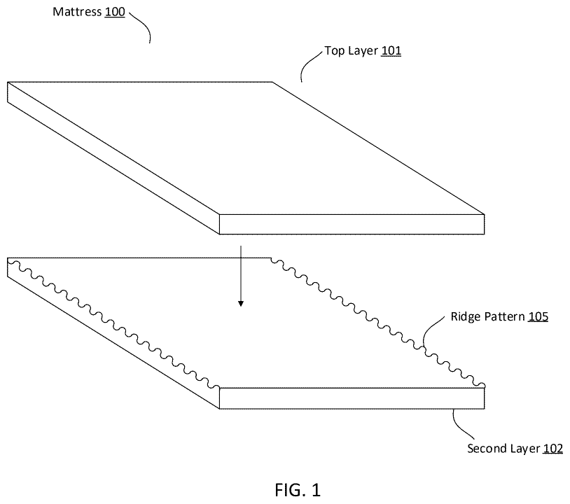

FIG. 1 is a perspective view of one embodiment of a foam mattress in accordance with the disclosure. In the example shown, mattress 100 includes a top layer 101 and a second layer 102. Both top layer 101 and second layer 102 may be made of a foam material. In some embodiments, additional foam layers may also be present, although embodiments of a mattress using only the two layers shown are also possible and contemplated. The sizes of the layers may be used to form mattress 100 in any one of a number of different standard bed sized (e.g., king size, queen size, etc.), or of any other desired size, including custom sizes.

As defined herein, a top layer of the mattress is a layer upon which, e.g., a person lies on the mattress. Furthermore, as defined herein, the term “top” with respect to a surface of a given foam layer is the surface of that layer closest to the top layer. Similarly, the term “bottom” with respect to a surface of a foam layer is the surface thereof furthest from the top layer. The disclosure further contemplates double-sided mattresses, wherein either of the two largest sides can serve as the top side or bottom side.

Second layer 102 in the illustrated example is cut with a ridged pattern 105 on its top surface. This ridged pattern 105 may include a number of ridges that extend across second layer 102. As will be discussed in additional detail below, various dimensions of these ridges may affect the overall firmness of mattress 100. Accordingly, these dimensions may be adjusted during the manufacturing process in order to fabricate instances of the mattress at desired firmness levels.

In some implementations, a bottom surface of top layer 101 may include a ridged pattern that is the same or similar to that of ridge pattern 105. Accordingly, the ridged patterns on these layers may be complementary and conformal to one another when top layer 101 and second layer 102 are in contact with one another in the final mattress product. However, embodiments in which the bottom surface of top layer 102 is substantially flat are also possible and contemplated.

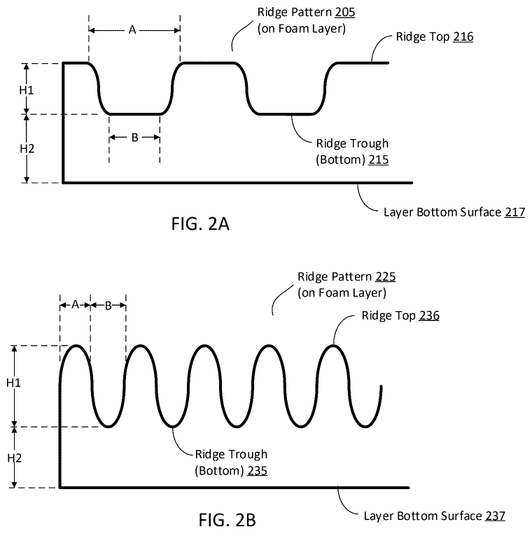

FIGS. 2A and 2B illustrate side views of ridge patterns that may be cut into a layer of a foam mattress in accordance with the disclosure. In FIG. 2A, a ridge pattern 205 that may be cut into a layer of a foam mattress is substantially flat on the ridge tops 216 as well as on the ridge trough (or bottom) 215.

Various dimensions associated with the ridge pattern 205 (and thus the foam layer into which it is cut) may affect the firmness of the overall finished mattress. In this example, the dimension H1 is the height of each ridge, from an adjacent ridge trough 215 to a ridge top 216. The dimension H2 as shown here is the distance between a ridge trough 215 and the bottom surface 217 of the mattress layer. These dimensions, and the ratio of one to another, may affect the overall firmness of the finished mattress. For example, in the case in which H1 is greater than H2, the larger the ratio of H1 to H2, the softer the finished mattress will be. When H2 is greater than H1, a larger ratio of H2 to H1 will result in a firmer finished mattress.

The dimensions A and B may also affect the firmness of the finished mattress. The dimension A in FIG. 2A spans between the end of one ridge top 216 and the beginning of the next ridge top 216. The dimension B spans the distance of the flat portion of ridge trough 215. In the case where A is greater than B, larger values of A will result in a softer finished product. In the case where B is greater than A, larger values of B will result in a firmer finished product.

Accordingly, a foam mattress according to the present disclosure may be manufactured according to a desired firmness by controlling the dimensions H1, H2, A, and B. Furthermore, having controllable dimensions (H1 and H2) along a vertical access and controllable dimensions (A and B) along a horizontal access may allow for a high degree of fine-tuning the desired firmness and/or weight of a foam mattress in accordance with the disclosure.

FIG. 2B illustrates another example of a ridge pattern. In this example, ridge pattern 225 is substantially sinusoidal in shape. Similar to the embodiment discussed above with reference to FIG. 2A, a dimension H1 is defined as a distance between a ridge trough 235 and a ridge top 236. Dimension H2 is defined as a distance between a ridge trough 235 and layer bottom surface 237. Dimensions A and B as shown here are centered around ridge top 236 and a ridge bottom 235, respectively. The shape of the sinusoidal ridge pattern is adjustable to achieve desired values of H1, H2, A, and B to obtain a corresponding level of firmness in the mattress. Moreover, the firmness of the mattress may adjusted by changing these dimensions in largely the same manner as that described above with reference to FIG. 2A.

It is noted that FIGS. 2A and 2B are provided here by way of example, but are not intended to be limiting the respective shapes of ridges and ridge patterns that are possible according to the disclosure. On the contrary, a wide variety of ridge patterns/shapes (e.g., sawtooth, square wave, etc.) are possible and contemplated by the present disclosure. The various shapes may each be defined at least in part by the dimensions A, B, H1 and H2 as discussed above, and adjustments to these dimensions may be carried out during the design and/or manufacturing process to obtain a desired firmness and/or weight of the finished mattress product.

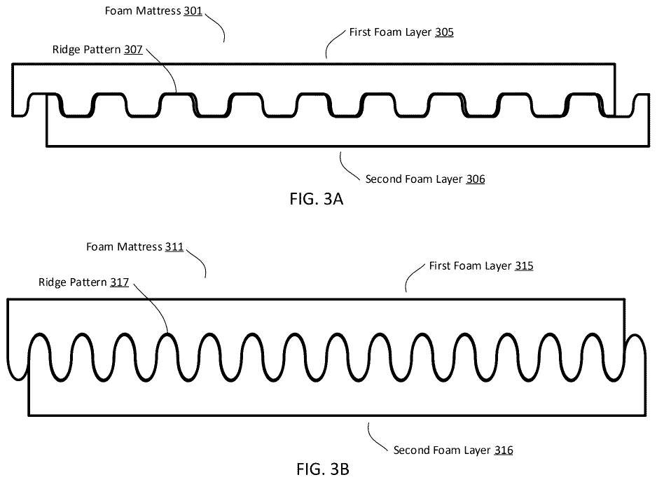

FIGS. 3A and 3B illustrate side views of foam layers of a mattress having complementary and conformal ridge patterns. In FIG. 3A, foam mattress 301 includes a first foam layer 305 and a second foam layer 306 each having a ridge pattern 307. When these two layers are placed together in the manner shown, the ridge patterns are conformal and complementary to one another. That is, the matching of the ridge pattern 307 on each of first foam layer 305 and second foam layer 306 may thus allow these layers to be assembled into a mattress with minimal space there between. FIG. 3B illustrates a similar arrangement, with foam mattress 311 including a first foam layer 315 and a second foam layer 316 each having a sinusoidal shaped ridge pattern 317. In various embodiments of a mattress according to the disclosure, at least some layers may be cut with complementary and conformal ridge patterns such that they may be placed adjacent to one another in the manner shown here. However, as will be discussed below, the various foam layers of a given mattress embodiment need not have complementary ridge patterns.

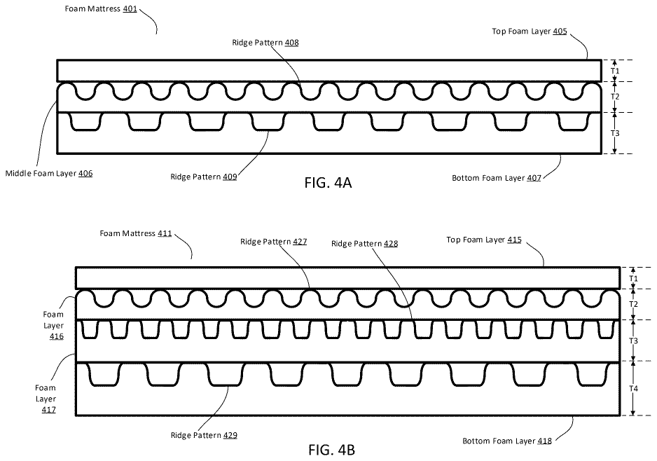

FIGS. 4A and 4B illustrate side views of mattresses having multiple layers with different ridge patterns. Foam mattress 401 of FIG. 4A includes three foam layers - top foam layer 405, middle foam layer 406, and bottom foam layer 407, which have thicknesses of T1, T2, and T3, respectively. Each of the foam layers shown here has a flat bottom surface. Middle foam layer 406 has a ridge pattern 408, while bottom foam layer 407 has a different ridge pattern 409. The firmness of foam mattress 401 may be determined at least in part by the dimensions H1, H2, A, and B for ridge patterns 408 and 409. Having two different layers with ridge patterns as shown here may allow for further fine-tuning of the desired firmness and/or weight of foam mattress 401.

Foam mattress 411 of FIG. 4B includes four foam layers - top foam layer 415, foam layer 416, foam layer 417, and bottom foam layer 418, which have thicknesses T1, T2, T3, and T4, respectively. These layers may be respectively referred to as a comfort layer, a support core, and a base layer. To foam layer 416 is cut with a ridge pattern 427, foam layer 417 is cut with a ridge pattern 428, and bottom foam layer 418 is cut with ridge pattern 429. Each of these ridge patterns are different from one another, with their own unique values of the dimensions H1, H2, A, and B. Accordingly, additional, fine-tuning of the overall mattress firmness and/or weight may be carried out based on these dimensions.

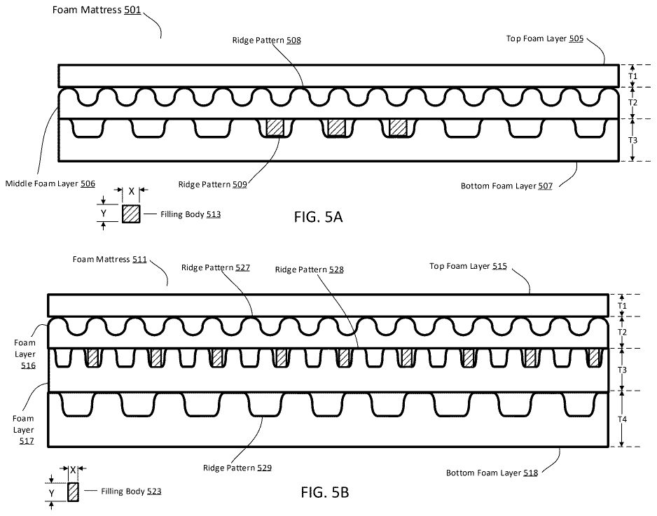

FIGS. 5A and 5B illustrate respective side views of mattresses having multiple layers with different ridge patterns and filling bodies disposed between selected ones of the ridges. Foam mattress 501 of FIG. 5A includes a top foam layer 505, a middle foam layer 506, and a bottom foam layer 507, the layers having thicknesses of T1, T2, and T3, respectively. Middle foam layer 506 is formed with a ridge pattern 508, while bottom foam layer 507 is formed with a ridge pattern 509.

Additionally, foam mattress 501 in the illustrated example includes a number of filling bodies 513 that are disposed in the spaces defined by the troughs of ridge pattern 509. These filling bodies 513 may be made of a soft material that may be compressed when weight is placed on foam mattress 501. Embodiments that use other materials (e.g., hard sponge) are also possible and contemplated. In some embodiments, the material used to make filling bodies 513 may be the same foam material used in the various foam layers of mattress 501. Other materials, such as cotton, may also be used in various embodiments. The filling bodies 513 may each, in some embodiments, have a horizontal dimension X and a vertical dimension Y. Adjusting these dimensions of filling bodies 513 may in turn alter their firmness. Thus, through adjustments of their respective dimensions and placement, filling bodies 513 may provide an additional adjustment to the firmness of the mattress 501 overall.

Foam mattress 511 of FIG. 5B includes four layers, top layers 515, foam layer 516, foam layer 517, and bottom foam layer 518, with respective thicknesses of T1, T2, T3, and T4. Foam layer 516 is formed with ridge pattern 527, foam layer 517 is formed with a ridge pattern 528, and bottom foam layer 518 is formed with a ridge pattern 529. Additionally, foam mattress 511 also includes a number of filling bodies selectively disposed in the spaces left by ridge pattern 528. Similar to the embodiment above, filling bodies 523 have an X dimension and a Y dimension that is adjustable from one embodiment to the next, and are made of a soft material. Along with the other dimensional adjustments discussed above, the placement and dimensions of instances of filling body 523 may be adjusted to further fine-tune the firmness and/or weight of foam mattress 511.

FIG. 6 is a flow diagram illustrating a method for manufacturing a foam mattress according to the disclosure. Method 600 as discussed herein may be used to manufacture any of the various embodiments of a mattress according to the disclosure.

Method 600 includes forming a first foam layer (block 605) and forming a second foam layer (block 610). Forming the second foam layer comprises forming, on a top surface of the second foam layer, a first ridged pattern having a first plurality of ridges. Method 600 further includes bonding the first foam layer to the second foam layer such that a bottom surface of the first foam layer is in contact with the top surface of the second foam layer (block 615). Any suitable bonding technique (e.g., such as the application of adhesives) may be used to bond the first foam layer to the second foam layer. Furthermore, the first ridged pattern has a first dimension between two ridges of the first plurality of ridges and a second dimension at a bottom of between ridges of the first plurality of ridges, wherein a firmness of the mattress is dependent on a ratio of the first dimension and the second dimension.

In various implementations, the method includes manufacturing a first instance of the mattress in which the second dimension is greater than the first dimension and manufacturing a second instance of the mattress in which the first dimension is greater than the second dimension. The firmness of the first instance of the mattress is greater than the firmness of the second instance of the mattress based on respective and relative values of the first and second dimensions.

Embodiments of the method may further includes forming the second foam layer such that ones of the plurality of ridges have a first height from a trough between ones of the plurality of ridges to a top of ones of the plurality of ridges, and a second height between the trough of between ones of the plurality of ridges and a bottom surface of the second foam layer, and wherein the firmness of the mattress is further dependent on a ratio of the first height to the second height.

In some embodiments, the method includes forming a bottom surface of the first foam layer such that the top surface of the second foam layer conforms to and is complementary with the first ridged pattern as formed on the bottom surface of the first foam layer.

The method may further include forming the first ridged pattern such that a top portion of ones of the first plurality of ridges is flat and a bottom portion between the ones of the first plurality of ridges is flat, and wherein a dimension of the top portion is equal to a dimension of the bottom portion. Another embodiment of the method may include forming the first ridged pattern to be sinusoidal in shape.

In one embodiment, the method includes forming a third foam layer, wherein forming the third foam layer comprises forming a top surface of the third foam layer with a second ridged pattern having a second plurality of ridges and bonding the top surface of the third foam layer to a bottom surface of the second foam layer. Various embodiments may include disposing one or more filling bodies between selected ones of the second plurality of ridges. Some embodiments of the method may also include forming a fourth foam layer and bonding a top surface of the fourth foam layer to a bottom surface of the third foam layer.

The present disclosure further contemplates embodiments in which the firmness/softness of the foam mattress may be adjusted “on the fly” by the consumer at home or, more generally, outside of the place of manufacture. This may be accomplished using the filling bodies introduced above with reference to FIGS. 5A and 5B. Such embodiments are now discussed in further detail.

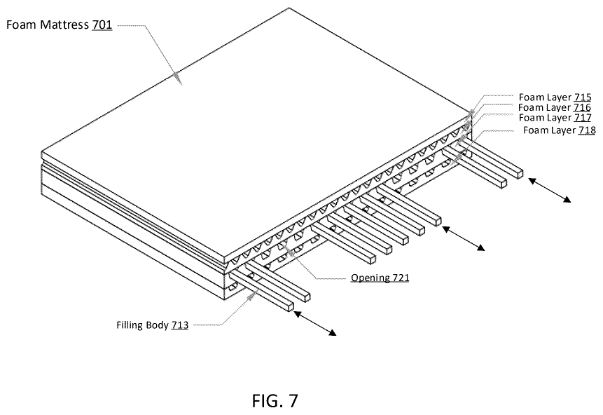

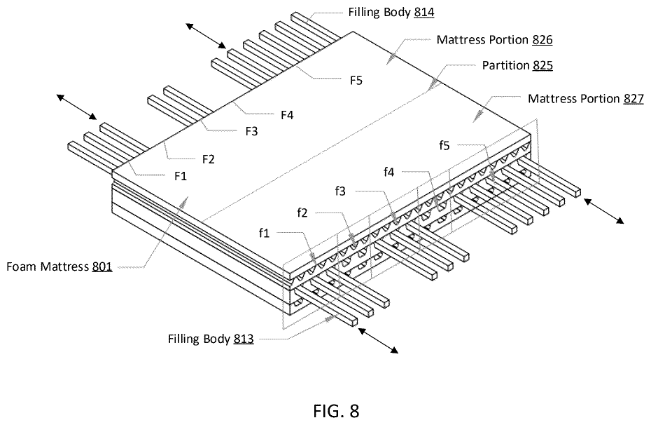

FIG. 7 is a perspective view of one embodiment of a foam mattress having an adjustable firmness using filling bodies in accordance with the disclosure. In the embodiment shown, foam mattress 701 includes a plurality of foam layers 715-718. Some of the foam layers, such as foam layers 716, 717, and 718, include ridged patterns as discussed above. In the particular embodiment, the bottom of each of the foam layers 715-718 is flat, and thus the ridge patterns form openings 721. The availability of the space formed by these openings enables the insertion of filling bodies 713, which may be used adjust the overall firmness of the mattress. In some embodiments, the filling bodies 713 may extend through an opening 721 in foam mattress from one side to the other. However, embodiments where shorter filling bodies are used to adjust the firmness of only portions of the mattress are also possible and contemplated, and are discussed in further detail below with reference to FIG. 8.

In this particular example, the filling bodies 713 inserted into openings 721 formed by the ridged pattern on foam layer 717, which is disposed beneath (and in contact with) foam layer 716, which has a flat bottom surface. The firmness or softness of particular portions of foam mattress 701 may be adjusted by selectively inserting and/or removing filling bodies 713 from corresponding openings 721. Accordingly, in a given configuration, some of the openings 721 may have a filling body 713 inserted therein, while others may remain unfilled. When fully inserted, a filling body 713 may remain within a corresponding opening 721 such that no part of it extends from that opening.

The use of the filling bodies 713 to adjust the firmness of mattress 701 may enable such adjustments to be carried out by, e.g., a consumer at home. Since the insertion and removal of the filling bodies 713 is a straightforward, easy process, no other special equipment or skills are required for adjusting the firmness of the various embodiments of mattress 701. Accordingly, a user of mattress 701 may be able to adjust the firmness thereof to a desired level.

Further fine-tuning of the firmness of the firmness of mattress 701 may be obtained by using filling bodies 713 with different core materials. For example, one filling body 713 may include a foam similar to that used in one or more layers 715-718, while another filling body 713 may be made of a different material, such as a hard sponge material. This may enable fine and selective adjustments of the firmness of the mattress 701 at various points for, e.g., providing additional support in one area while providing a desired softness in another area.

FIG. 8 illustrates another embodiment of a foam mattress with a firmness that is adjustable utilizing filling bodies. In this embodiment, mattress 801 includes a partition 825 such that it is subdivided into two portions, mattress portion 826 and mattress portion 827. This subdividing of the mattress 801 allows for the firmness/softness of mattress partitions 826 and 827 to be adjusted separately and independently from one another using filling bodies as discussed above with reference to FIG. 7.

In this embodiment, filling bodies 814 may be removably inserted into openings on the side of mattress portion 826, while filling bodies 813 may be removably inserted into openings on the side of mattress portion 827. The length of filling bodies 813 and 814 may be such that they extend substantially from the respective side in which they are inserted up to the partition (which may be implemented as a physical barrier in the various foam layers of foam mattress 801.

FIG. 8 further illustrates zoning of the respective partitions 826 and 827. In the example embodiment shown, mattress partition 826 includes zones F1-F5 (capital ‘F’), while mattress partition 826 includes zones f1-f5 (lower case ‘F’). These different zones may correspond to different portions of a human body, and thus allow the firmness of their respective partition to be adjusted within each. For example, the F1/f1 zones may correspond to the head/neck of a person, F2/f2 correspond to shoulders and upper back, and so on. Accordingly, a person who sleeps on mattress 801 may adjust the firmness/softness of their particular one of partitions 826-827 by selectively inserting and removing instances of filling bodies 814 and 813, respectively. In one example, a person sleeping on mattress portion 826 may adjust the firmness as described here for the head/neck area F1, while a user that sleeps on mattress portion 827 may separately and independently adjust the firmness of head/neck area f1 to a different level.

It is noted that the ability to adjust the firmness of different zones as described herein may also be carried out for the full mattress shown in FIG. 7.

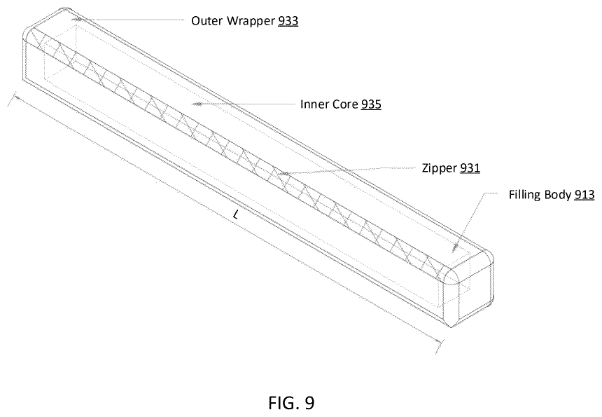

FIG. 9 is a perspective view of one embodiment of a filling body in accordance with the disclosure. In the embodiment shown, filling body 913 comprises an outer wrapper 933, an inner core 935, and a zipper 931. The zipper 931 may be opened to allow the replacement of the inner core 935 (and thus, the material thereof). As noted above, the material of inner core 935 may be different from one instance of a filling body 913 to the next. Non-limiting examples of such materials may include foams of various firmness level, hard sponge materials, and so on.

Filling body 913 in the example shown includes a particular length L. This length may vary both with the overall size of the mattress for which its use is intended, as well as whether or not the mattress is partitions. For example, the length of an embodiment of filling body 913 used with mattress 701 of FIG. 7 may be such that it extends substantially through the mattress from one side to another. In another embodiment, the length of a filling body may be such that it extends from the side of the mattress from which it is to be inserted up to the partition, such as with mattress 801 of FIG. 8.

Outer wrapper 933 in various embodiments may be made of a relatively low friction material in order to facilitate easy insertion and removal of a filling body 913. For example, and suitable cloth material that does not generate an excessive amount of friction with the foam material of a particular foam layer.

FIG. 10 is a flow diagram illustrating a method for adjusting a firmness of a foam mattress. In the embodiment shown, Method 100 inserting or removing filling bodies in a first partition to obtain a desired firmness for that partition (block 1005). The method further includes inserting or removing filling bodies in a second partition to obtain the desired firmness of that partition, with the firmness of the first and second partitions being separately and independently adjustable from one another (block 1010).

It is noted that in un-partitioned embodiments of a mattress, the method may be carried out by applying block 1005 without block 1010.

Accordingly, the disclosure contemplates a foam mattress in which the firmness is adjustable in multiple ways. Some of the methods of adjusting firmness are carried out during the manufacturing process, as discussed above with reference to FIGS. 1-6. Other methods of adjusting the firmness may be carried out in an after-manufacturing environment, by the consumer, using the filling bodies as discussed with reference to FIGS. 7-10. Both methods of adjusting the firmness are possible in various embodiments given the various ridge patterns disclosed herein, as well as with the presences of a desired number of filling bodies.

It will be understood that the terms “include,” “including,” “comprise,” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be further understood that, although the terms “first,” “second,” “third,” etc., may be used herein to describe various elements, components, regions, layers and/or sections, these elements, components, regions, layers and/or sections may not be limited by these terms. These terms are only used to distinguish one element, component, region, layer or section from another element, component, region, layer or section.

As used herein, the term “and/or” includes any and all combinations of one or more of the associated listed items. Expressions such as “at least one of,” when preceding a list of elements, modify the entire list of elements and do not modify the individual elements of the list.

Various terms are used to refer to particular system components. Different companies may refer to a component by different names - this document does not intend to distinguish between components that differ in name but not function.

Matters of these example embodiments that are obvious to those of ordinary skill in the technical field to which these example embodiments pertain may not be described herein in detail.

It may be understood that the example embodiments described herein may be considered in a descriptive sense only and not for purposes of limitation. Descriptions of features or aspects within each example embodiment may be considered as available for other similar features or aspects in other example embodiments.

While example embodiments have been described with reference to the figures, it will be understood by those of ordinary skill in the art that various changes in form and details may be made therein without departing from the spirit and scope as defined by the following claims.

What is claimed is:

1. A foam mattress comprising:
a plurality of foam layers including a first foam layer and a second foam layer, wherein second foam layer is disposed underneath the first foam layer, wherein a top surface of the second foam layer is formed with a first ridged pattern having a first plurality of ridges with corresponding ones of a first plurality of openings between ones of the first plurality of ridges;
at least one filling body disposed in a corresponding one of the first plurality of openings, wherein a firmness of the mattress is adjustable by inserting or removing the at least one filling body from the corresponding one of the plurality of openings.

2. The mattress of claim 1, further comprising a plurality of filling bodies including the at least one filling body, wherein the firmness of the mattress is further adjustable by inserting or removing ones of the plurality of filling bodies from corresponding ones of the plurality of openings.

3. The mattress of claim 2, further comprising a partition separating the mattress into a first portion and a second portion, wherein a first subset of the plurality of openings is located on a first side of the mattress associated with the first portion, and wherein a second subset of the plurality of openings is located on a second side of the mattress associated with the second portion.

4. The mattress of claim 3, wherein a firmness of the first portion of the mattress is adjustable, using a first subset of the plurality of filling bodies and wherein a firmness of the second portion of the mattress is adjustable using a second subset of the plurality of filling bodies, wherein the firmness of the first portion of the mattress and the firmness of the second portion of the mattress are adjustable independently of one another.

5. The mattress of claim 1, wherein the at least one filling body includes an outer wrapping having a zipper and an inner core of material removably placed within the outer wrapping.

6. The mattress of claim 5, wherein a material of the inner core for the at least one filling body is different from foam used in one of the first and second foam layers.

7. The mattress of claim 5, wherein a material of the inner core for a first filling body is different from a material of the inner core for a second filling body.

8. The mattress of claim 5, wherein a material of the inner core for a first filling body is a hard sponge material.

9. The mattress of claim 1, wherein the firmness of the mattress is further adjustable in zones corresponding to portions of a human body.

10. The mattress of claim 1, wherein the plurality of foam layers further comprises:
wherein the plurality of foam layers further comprises a third foam layer disposed above the first foam layer, wherein the third foam layer is a top foam layer; and
a fourth foam layer disposed underneath the second foam layer, wherein the fourth foam layer has a top surface in contact with a bottom surface of the second foam layer, and wherein the top surface of the fourth foam layer is formed with a second ridged pattern having a second plurality of ridges.

11. A method comprising:
adjusting a firmness of a foam mattress, wherein adjusting the firmness of the foam mattress comprises:
manipulating a first filling body in one of a plurality of openings on a side of a foam mattress, wherein the foam mattress comprises a first foam layer and a second foam layer, wherein second foam layer is disposed underneath the first foam layer, wherein a top surface of the second foam layer is formed with a first ridged pattern having a first plurality of ridges with corresponding ones of the plurality of openings between ones of the first plurality of ridges.

12. The method of claim 11, wherein adjusting the firmness of the foam mattress further comprises inserting the first filling body into the one of a plurality of openings.

13. The method of claim 11, wherein adjusting the firmness of the foam mattress further comprises removing the first filling body from the one of the plurality of openings.

14. The method of claim 11, wherein foam mattress comprises a partition dividing the foam mattress into a first portion having a first subset of the plurality of openings on a first side of the foam mattress, and a second portion having a second subset of the plurality of openings on a second side of the foam mattress, and wherein the method further includes:
independently adjusting respective firmness of the first portion and the second portion independently from one another by manipulating a first one of a plurality of filling bodies in one of the first subset of the plurality of openings and manipulating a second one of the plurality of filling bodies in one of the second subset of the plurality of openings.

15. The method of claim 11, wherein adjusting the firmness of the foam mattress further comprises:
manipulating a second filling body in a different one of the plurality of openings, wherein a core material of the second filling body is different from a core material of the first filling body.

16. A foam mattress comprising:
a plurality of foam layers, the plurality of foam layers including:
a first foam layer;
a second foam layer disposed underneath the first foam layer, wherein a top surface of the second foam layer is formed with a first ridged pattern having a first plurality of ridges with corresponding ones of a first plurality of openings between ones of the first plurality of ridges; and
a third foam layer disposed underneath the second foam layer, wherein a top surface of the third foam layer is formed with a second ridged pattern having a second plurality of ridges with corresponding ones of a second plurality of openings between ones of the first plurality of ridges; and
at least one filling body disposed in a corresponding one of the first plurality of openings or second plurality of openings, wherein a firmness of the mattress is adjustable by inserting or removing the at least one filling body from the corresponding one of the first plurality of openings or second plurality of openings.

17. The foam mattress of claim 16, wherein the second ridged pattern is different from the first ridged pattern.

18. The foam mattress of claim 16, wherein the foam mattress includes a partition that subdivides the foam mattress into a first portion and a second portions, wherein, using first and second ones of a plurality of filling bodies, a firmness of the first portion and a firmness of the second portion are independently adjustable with respect to one another.

19. The foam mattress of claim 16, wherein the at least one filling body is one of a plurality of filling bodies, wherein each of the plurality of filling bodies includes an outer wrapping and a core material enclosed within the outer wrapping.

20. The foam mattress of claim 19, wherein a core material of a first one of the plurality of filling bodies is different from a core material of a second one of the plurality of filling bodies.
